(19) United States
(12) Patent Application Publication
(10) Pub. No.: US 2023/0174766 A1
(43) Pub. Date: Jun. 8, 2023

(54) LOW SPECIFIC GRAVITY VIBRATION-DAMPING MATERIAL COMPOSITION WITH IMPROVED HIGH TEMPERATURE VIBRATION-DAMPING PROPERTIES

(71) Applicants: HYUNDAI MOTOR COMPANY, Seoul (KR); KIA CORPORATION, Seoul (KR); Shinsung Petrochemical Co.,Ltd, Seoul (KR)

(72) Inventors: Tae Yoon Kim, Daejeon (KR); Hong Chan Jeon, Seoul (KR); Mi Jung Yun, Seongnam-si (KR); Hyeon Cheol Song, Jincheon-gun (KR); Yoo Sang Jeong, Ulsan (KR); Woo Jin Kim, Seoul (KR)

(73) Assignees: HYUNDAI MOTOR COMPANY, Seoul (KR); KIA CORPORATION, Seoul (KR); Shinsung Petrochemical Co.,Ltd, Seoul (KR)

(21) Appl. No.: 18/074,840

(22) Filed: Dec. 5, 2022

(30) Foreign Application Priority Data
Dec. 6, 2021 (KR) 10-2021-0172680

(51) Int. Cl. C08L 33/08

(52) U.S. Cl. CPC C08L 33/08

(57) ABSTRACT

A vibration-damping material composition is provided. More particularly, a low-specific gravity vibration-damping material composition is disclosed that includes improved high temperature damping by using a glass bubble, an acrylic copolymer including a first acrylic copolymer and a second acrylic copolymer having different glass transition temperature and weight average molecular weight.

### CROSS REFERENCE TO RELATED APPLICATION

The present application claims priority to Korean Patent Application No. 10-2021-0172680, filed Dec. 6, 2021, the entire contents of which are incorporated herein by reference.

### BACKGROUND

### 1. Technical Field

The present disclosure relates to a vibration-damping material composition. More particularly, the present disclosure relates to a low-specific gravity vibration-damping material composition having improved high temperature vibration-damping by using a glass bubble, and an acrylic copolymer including a first acrylic copolymer and a second acrylic copolymer having different glass transition temperature and weight-average molecular weight.

### 2. Description of the Related Art

The statements in this section merely provide background information related to the present disclosure and may not constitute prior art.

The vibration-damping material composition may be applied to the floor inside the panel of the vehicle body for vibration-damping and soundproofing. The vibration-damping material composition used herein has an acrylic emulsion resin as the main component and is prepared by mixing fillers, dispersants, and various additives.

Recently, the vibration-damping material composition requires lightening of vehicles due to strengthened fuel efficiency and various regulations, and vibration-damping at high temperatures is required as an important physical property as the average temperature of the atmosphere increases and the temperature at the bottom of the internal combustion engine increases.

The conventionally used paste-type vibration-damping material composition uses calcium carbonate having a specific gravity of about 2.6 to 2.7 as a filler for filling and workability. As such, when calcium carbonate having a high specific gravity is used as a filler, the specific gravity of the vibration-damping material composition also increases, which is a factor hindering the lightening of vehicles.

Therefore, under the above background, there is a need to develop a vibration-damping material composition that can be applied to automobiles by reducing specific gravity and having excellent vibration-damping properties even at high temperatures.

### SUMMARY

An objective of the present disclosure is to provide a vibration-damping material composition for a vehicle having a low specific gravity and excellent vibration damping properties even at a high temperature.

The objective of the present disclosure is not limited to the object mentioned above. The objective of the present disclosure becomes more apparent from the following description and is realized by means and combinations thereof described in the claims.

The vibration-damping material composition, according to the present disclosure, includes: an acrylic copolymer mixture including a first acrylic copolymer and a second acrylic copolymer having a higher weight-average molecular weight (Mw) and higher glass transition temperature (Tg) than the first acrylic copolymer; and a filler including a glass bubble, calcium carbonate, and a mica.

The vibration-damping material composition may include 20% to 60% by weight of the acrylic copolymer mixture, 1% to 10% by weight of the glass bubble, 15% to 50% by weight of the calcium carbonate, and 5% to 20% by weight of the mica.

The acrylic copolymer mixture may include the first acrylic copolymer and the second acrylic copolymer in a weight ratio of 1:1 to 1:3.

The first acrylic copolymer may have a weight-average molecular weight (Mw) in a range of 10,000 g/mol to 80,000 g/mol and a glass transition temperature (Tg) in a range of −30° C. to 0° C.

The second acrylic copolymer may have a weight-average molecular weight (Mw) in a range of 40,000 g/mol to 120,000 g/mol and a glass transition temperature (Tg) in a range of -10° C. to 30° C.

The glass bubble may have a specific gravity in a range of 0.1 to 2.0.

The glass bubble may have an average particle diameter in a range of 10 μm to 30 μm.

The glass bubble may have a crushing strength in a range of 30 MPa to 60 MPa.

The calcium carbonate may have an average particle diameter in a range of 20 μm to 70 μm.

The mica may have an average particle diameter in a range of 5 μm to 20 μm.

The vibration-damping material composition further includes an additive, and the additive may include a colorant, a dispersant, an antifoaming agent, a thickener, or any combination thereof.

The additive may include 0.1% to 3% by weight of a colorant, 0.1% to 3% by weight of a dispersant, 0.1% to 3% by weight of an antifoaming agent, and 0.1% to 3% by weight of a thickener.

The vibration-damping material composition may have a specific gravity of 1.3 or less as measured according to ISO 1183-1.

The vibration-damping material composition may have a loss factor of 0.15 or more measured at 20° C. and a loss factor of 0.2 or more measured at 40° C. according to ASTM E 756.

The vibration-damping material composition, according to the present disclosure, is effective in reducing the weight of a vehicle by lowering the specific gravity to 1.3 or less by using glass bubbles as a filler.

In addition, the vibration-damping material composition, according to the present disclosure, uses an acrylic copolymer mixture including a first acrylic copolymer and a second acrylic copolymer having different glass transition temperatures and weight-average molecular weights and thus has an excellent vibration-damping property at high temperatures. Vibration suppression performance can be maintained even in a high temperature environment.

The effects of the present disclosure are not limited to the effects mentioned above. It should be understood that the effects of the present disclosure include all effects that can be inferred from the following description.

### DETAILED DESCRIPTION

The above objectives, other objectives, features, and advantages of the present disclosure are understood through the following embodiments. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those of having ordinary skill in the art.

In this specification, the term “include” or “have” should be understood to designate that one or more of the described features, numbers, steps, operations, components, or a combination thereof exist, and the possibility of addition of one or more other features or numbers, operations, components, or combinations thereof should not be excluded in advance. When a component, device, element, or the like of the present disclosure is described as having a purpose or performing an operation, function, or the like, the component, device, or element should be considered herein as being “configured to” meet that purpose or to perform that operation or function.

Unless otherwise specified, all numbers, values, and/or expressions expressing quantities of ingredients, reaction conditions, polymer compositions, and formulations used herein contain all numbers, values and/or expressions in which such numbers essentially occur in obtaining such values, among others. Because they are approximations reflecting various uncertainties in the measurement, they should be understood as being modified by the term “about” in all cases. In addition, when a numerical range is disclosed in this disclosure, this range is continuous and includes all values from the minimum to the maximum value containing the maximum value of this range unless otherwise indicated. Furthermore, when such a range refers to an integer, all integers, including the minimum value to the maximum value containing the maximum value, are included unless otherwise indicated.

In this specification, when a range is described for a variable, the variable is understood to include all values within the stated range, including the stated endpoints of the range. For example, it may be understood that the range of “5 to 10” includes values of 5, 6, 7, 8, 9, and 10, as well as any sub-range of 6 to 10, 7 to 10, 6 to 9, 7 to 9, and also include any value between integers reasonable in the range described, such as 5.5, 6.5, 7.5, 5.5 to 8.5 and 6.5 to 9, and the like. Also, for example, it may be understood that the range of “10% to 30%” includes values such as 10%, 11%, 12%, 13%, and all integers up to and including 30%, as well as any sub-range of 10% to 15%, 12% to 18%, 20% to 30%, etc., and also include any value between reasonable integers within the scope of the stated range, such as 10.5%, 15.5%, 25.5%, and the like.

The present disclosure relates to a low specific gravity damping composition with improved high-temperature vibration-damping properties. The present disclosure includes: an acrylic copolymer mixture including a first acrylic copolymer and a second acrylic copolymer having a higher weight-average molecular weight (Mw) and glass transition temperature (Tg) than the first acrylic copolymer; and a filler including a glass bubble, calcium carbonate, and a mica.

The vibration-damping material composition may further include an additive. The additive may include a colorant, a dispersant, an antifoaming agent, a thickener, or any combination thereof.

In one embodiment, the vibration-damping material composition includes 20% to 60% by weight of the acrylic copolymer mixture, 1% to 10% by weight of the glass bubble, 15% to 50% by weight of the calcium carbonate, and 5% to 20% by weight of the mica, 0.1% to 3% by weight of the colorant, 0.1% to 3% by weight of the dispersant, 0.1% to 3% by weight of the antifoaming agent, and 0.1% to 3% by weight of the thickener.

It is stated in advance that the content of each component of the vibration-damping material composition to be described below is based on 100% by weight of the vibration-damping material composition. If the standard is changed, the changed standard is specified, so those ordinary skilled in the art are able to know what composition the content is based on.

Each component constituting the vibration damper composition according to the present disclosure are described in more detail as follows.

(1) Acrylic Copolymer Mixture

The acrylic copolymer mixture includes a first acrylic copolymer and a second acrylic copolymer.

The acrylic copolymer mixture is included in an amount of 20% to 60% by weight with respect to the total content of the vibration-damping material composition. At this time, when the content of the acrylic copolymer mixture is less than 20% by weight, a vibration-damping property and adhesive strength are lowered. Further, when the content of the acrylic copolymer mixture exceeds 60% by weight, there may be problems in that an ejection property and workability are reduced.

The acrylic copolymer mixture may include the first acrylic copolymer and the second acrylic copolymer in a weight ratio of 1:1 to 1:3. When the weight ratio of the acrylic copolymer mixture falls within the above numerical range, vibration-damping properties at high temperatures may be improved.

The first acrylic copolymer and the second acrylic copolymer may be prepared by polymerizing at least one monomer such as methyl methacrylate, butyl acrylate, ethylhexyl acrylate, or any combination thereof. In this case, the weight-average molecular weight of the acrylic copolymer may be controlled by adding a molecular weight modifier to the raw material of the acrylic copolymer. Specifically, the molecular weight modifier may use dodecyl mercaptan.

The first acrylic copolymer has a lower weight-average molecular weight (Mw) and a lower glass transition temperature (Tg) than the second acrylic copolymer.

According to the present disclosure, two acrylic copolymers having a different weight-average molecular weight (Mw) and glass transition temperature (Tg) are mixed and used, thereby implementing vibration-damping material composition having excellent vibration control even at high temperatures.

Specifically, the first acrylic copolymer may have a weight-average molecular weight (Mw) in a range of 10,000 g/mol to 80,000 g/mol and a glass transition temperature (Tg) in a range of −30° C. to 0° C. The second acrylic copolymer may have a weight-average molecular weight (Mw) in a range of 40,000 g/mol to 120,000 g/mol and a glass transition temperature (Tg) in a range of −10° C. to 30° C.

The acrylic copolymer mixture controls the physical properties and the weight ratio of each of the first acrylic copolymer and the second acrylic copolymer, thereby inducing movement of a molecular structure capable of efficiently absorbing external impact and energy, thereby improving vibration-damping control and soundproof performance.

(2) Filler

The filler may include a glass bubble, calcium carbonate, and a mica.

The glass bubble is a hollow microparticle with very low specific gravity but high strength. Therefore, when the glass bubble is used together with fillers such as calcium carbonate and a mica, the specific gravity can be greatly reduced while maintaining or improving vibration-damping properties.

The glass bubble is included in an amount in a range of 1% to 10% by weight with respect to the total content of the vibration-damping material composition. At this time, when the content of the glass bubble is less than 1% by weight, the specific gravity reduction effect is insignificant. Further, when the content of the glass bubble exceeds 10% by weight, workability may be reduced.

The glass bubble may have a specific gravity in a range of 0.1 to 2.0. When the specific gravity falls within the above numerical range, the specific gravity of the vibration-damping material composition may be reduced to the desired level.

The glass bubble may have an average particle diameter in a range of 10 μm to 30 μm.

The glass bubble may have a crushing strength in a range of 30 MPa to 60 MPa. If the crushing strength is less than 30 MPa, it cannot withstand the pressure applied to the glass bubble when the vibration-damping material composition is applied by a robot.

The calcium carbonate is intended to impart fillability, dischargeability, and flowability in the vibration-damping material composition and is included in an amount in a range of 15% to 50% by weight with respect to the total content of the vibration-damping material composition. At this time, when the content of calcium carbonate is less than 15% by weight, a pattern may not be formed when the vibration-damping material composition is applied by a robot. Further, when the content of calcium carbonate is more than 50% by weight, adhesive strength and workability may be reduced. Specifically, the calcium carbonate may have an average particle diameter in a range of 20 μm to 70 μm.

The mica is intended to impart fillability, dischargeability, and flowability in the vibration-damping material composition and is included in an amount in a range of 5% to 20% by weight with respect to the total content of the vibration-damping material composition. At this time, when the content of the mica is less than 5% by weight, vibration damping properties are lowered. Further, when the content of the mica exceeds 20% by weight, workability may be deteriorated. Specifically, the mica may have an average particle diameter of 5 μm to 20 μm.

(3) Additives

The additive may include a colorant, a dispersant, an antifoaming agent, a thickener, or any combination thereof.

The colorant may be included in an amount in a range of 0.1% to 3% by weight with respect to the total content of the vibration-damping material composition.

The colorant may be an inorganic colorant such as titanium oxide, carbon black, or iron oxide.

The dispersant may be included in an amount in a range of 0.1% to 3% by weight with respect to the total content of the vibration-damping material composition.

The dispersant may be an inorganic dispersant such as sodium hexametaphosphate or sodium tripolyphosphate or an organic dispersant such as a polycarboxylic acid-based dispersant.

The antifoaming agent may be included in an amount of 0.1% to 3% by weight with respect to the total content of the vibration-damping material composition. The antifoaming agent may be a silicone-based antifoaming agent.

The thickener may be included in an amount of 0.1% to 3% by weight based on the total content of the composition. The thickener may include polyvinyl alcohol, cellulose-based derivatives, polycarboxylic acid-based resins, polyether-based derivatives, or any combination thereof.

The vibration-damping material composition may have a specific gravity of 1.3 or less as measured according to ISO 1183-1. The lower limit of the specific gravity of the damping material composition is not particularly limited, and for example, the specific gravity may be 0.9, 0.8, 0.7, or 0.6.

The vibration damping properties of the vibration-damping material composition can be determined through the loss factor. The vibration-damping material composition may have a loss factor of 0.15 or more measured at 20° C. according to ASTM E 756. In this case, the upper limit of the loss factor measured at 20° C. is not particularly limited, and for example, the loss factor may be 0.25. In addition, the loss factor measured at 40° C. may be 0.2 or more. At this time, the upper limit of the loss factor measured at 40° C. is not particularly limited, and for example, the loss factor may be 0.4.

Hereinafter, the present disclosure are described in more detail with reference to a specific example. The following examples are merely illustrative to help the understanding of the present disclosure, and the scope of the present disclosure is not limited thereto.

### EXAMPLES 1 TO 7 AND COMPARATIVE EXAMPLES 1 TO 5

As shown in Tables 1 and 2 below, components were blended to prepare vibration-damping material composition. At this time, the first acrylic copolymer and the second acrylic copolymer were prepared in the copolymer preparation example of the following method.

Copolymer Preparation Example

A pre-emulsion was prepared by adding 30 parts by weight of sodium sulfate salt, 220 parts by weight of methyl methacrylate, 210 parts by weight of butyl acrylate, 5 parts by weight of ethylhexyl acrylate, 5 parts by weight of methacrylic acid, and 4 parts by weight of dodecyl mercaptan to 190 parts by weight of deionized water.

After adding 1 part by weight of sodium carbonate to 230 parts by weight of deionized water, the temperature was raised to about 70° C. while stirring, and the reaction was performed while maintaining the temperature. Then, 30 parts by weight of a 25% ammonium persulfate solution were added and maintained for about 10 minutes. Then, 5% of the pre-emulsion was initially added, and the temperature was raised to 80° C. while controlling the exothermic reaction and maintained for about 15 minutes. Subsequently, the remaining pre-emulsion was reacted by dropping the pre-emulsion together with 112 parts by weight of 6% ammonium persulfate for 3 hours. Then, after completion of the drop-off, 3 parts by weight of a 10% solution of tertbutyl hydroperoxide and 3 parts by weight of a 10% solution of FF6M were added, maintained at 80° C. for 1 hour, and then cooled to room temperature.

Finally, by controlling the degree of reaction of the pre-emulsion, a first acrylic copolymer and a second acrylic copolymer having the following weight-average molecular weight and glass transition temperature were prepared.

[Each Component Constituting the Vibration-Damping Material Composition]

First acrylic copolymer: an acrylic copolymer prepared in the above Preparation Example, having a molecular weight of 50,000 to 60,000 g/mol and a glass transition temperature of −3° C.

Second acrylic copolymer: an acrylic copolymer prepared in Preparation Example, having a molecular weight of 60,000 to 80,000 g/mol and having a glass transition temperature of 0° C.

Filler:
Calcium carbonate: calcium carbonate particles with an average particle diameter of 20 μm to 70 μm as raw limestone
Mica: mica particles with an average particle diameter of 5 μm to 20 μm as raw mica
Glass bubble: vs7000, 3M Company
(4) Colorants: inorganic colorant
(5) Antifoaming agent: silicone-based antifoaming agent
(6) Dispersants: organic dispersant
(7) Thickeners: polyvinyl alcohol, cellulose derivatives, polycarboxylic acid resins, polyether-based derivatives.

TABLE 1

| | | Example | | | | | | |
|---|---|---|---|---|---|---|---|---|
| Ingredients (wt.%) | | 1 | 2 | 3 | 4 | 5 | 6 | 7 |
| Acrylic | First acrylic | 15 | 15 | 10 | 15 | 15 | 15 | 15 |
| mixture | copolymer | | | | | | | |
| copolymer | Second acrylic | 25 | 25 | 30 | 25 | 28 | 25 | 25 |
| | copolymer | | | | | | | |
| Filler | Calcium | 43 | 41 | 43 | 42 | 38 | 41 | 36 |
| | carbonate | | | | | | | |
| | Mica | 10 | 10 | 10 | 10 | 10 | 10 | 10 |
| | Glass Bubble | 3 | 5 | 3 | 4 | 5 | 5 | 10 |
| Additive | Colorant | 1 | 1 | 1 | 1 | 1 | 1 | 1 |
| | Antifoaming | 1 | 1 | 1 | 1 | 1 | 1 | 1 |
| | agent | | | | | | | |
| | Dispersant | 1 | 1 | 1 | 1 | 1 | 1 | 1 |
| | Thickener | 1 | 1 | 1 | 1 | 1 | 1 | 1 |

TABLE 2

| | | (Comparative Example) | | | | |
|---|---|---|---|---|---|---|
| Ingredients (wt. %) | | 1 | 2 | 3 | 4 | 5 |
| Acrylic | First acrylic copolymer | 30 | 40 | 0 | 15 | 15 |
| mixture | | | | | | |
| copolymer | Second acrylic copolymer | 10 | 0 | 40 | 20 | 20 |
| Filler | Calcium carbonate | 43 | 43 | 43 | 46 | 51 |
| | Mica | 10 | 10 | 10 | 15 | 10 |
| | Glass Bubble | 3 | 3 | 3 | 0 | 0 |
| Additive | Colorant | 1 | 1 | 1 | 1 | 1 |
| | Antifoaming agent | 1 | 1 | 1 | 1 | 1 |
| | Dispersant | 1 | 1 | 1 | 1 | 1 |
| | Thickener | 1 | 1 | 1 | 1 | 1 |

Each of the prepared vibration-damping material compositions was measured for physical properties in the following method, and the results are shown in Tables 3 and 4 below.

Specific gravity was measured according to ISO 1183-1. Here, the specific gravity was measured using a specific gravity cup.

Loss factor was measured using a vibration-damping tester (Ono Sokki Co., Ltd.) according to ASTM E 756. At this time, the loss factor at the 500 Hz anti-resonance point was measured by the central excitation method under the conditions of measuring temperatures of 20° C. and 40° C. Here, the larger the loss factor, the higher the vibration-damping properties.

TABLE 3

| | | Example | | | | | | |
|---|---|---|---|---|---|---|---|---|
| Division | | 1 | 2 | 3 | 4 | 5 | 6 | 7 |
| Properties | Specific | 1.28 | 1.08 | 1.28 | 1.21 | 1.02 | 1.08 | 0.98 |
| | gravity | | | | | | | |
| | Loss | 0.187 | 0.185 | 0.15 | 0.184 | 0.192 | 0.185 | 0.170 |
| | factor | | | | | | | |
| | (820° C.) | | | | | | | |
| | Loss | 0.243 | 0.251 | 0.284 | 0.244 | 0.276 | 0.224 | 0.24 |
| | factor | | | | | | | |
| | (@40° C.) | | | | | | | |

TABLE 4

| | | (Comparative Example) | | | | |
|---|---|---|---|---|---|---|
| Division | | 1 | 2 | 3 | 4 | 5 |
| Properties | Specific | 1.29 | 1.28 | 1.28 | 1.55 | 1.59 |
| | gravity | | | | | |
| | Loss factor | 0.21 | 0.23 | 0.098 | 0.17 | 0.165 |
| | (@20° C.) | | | | | |
| | Loss factor | 0.13 | 0.1 | 0.358 | 0.264 | 0.19 |
| | (@40° C.) | | | | | |

Referring to Table 3, Examples 1 to 7 were used in appropriate content of each component, and the specific gravity measured according to ISO 1183-1 was 0.98 to 1.28, and the loss factor measured at 20° C. according to ASTM E 756 was 0.15 to 0.192 and the loss factor measured at 40° C. was measured as 0.224 to 0.284, indicating that the loss factor is excellent while the specific gravity is low.

Accordingly, the vibration-damping material composition, according to the present disclosure, is effective in reducing the weight of a vehicle by lowering the specific gravity to 1.3 or less by using glass bubbles as a filler.

On the other hand, referring to Table 4, in Comparative Example 1, in which the weight ratio of the first acrylic copolymer and the second acrylic copolymer is out of a specific mixing ratio of 1:1 to 1:3, the loss factor measured at 40° C. is relatively low.

Therefore, it was confirmed that when the first acrylic copolymer and the second acrylic copolymer were mixed and used, unsatisfactory results were obtained when the mixture was outside the specific mixing ratio of 1:1 to 1:3.

In addition, Comparative Example 2 using the first acrylic copolymer alone had a relatively low loss factor measured at 40° C.

Comparative Example 3 using the second acrylic copolymer alone had a relatively low loss factor measured at 20° C.

Therefore, it can be confirmed that the vibration-damping material composition has excellent vibration-damping properties at high temperatures only when the first acrylic copolymer and the second acrylic copolymer which have different glass transition temperatures and weight-average molecular weights are used.

In Comparative Examples 4 and 5, which did not include the glass bubble, the specific gravity was measured to be 1.55 and 1.59, respectively, because the ratio of calcium carbonate and mica in the filler was too high, and the specific gravity was measured to be relatively high compared to Examples 1 to 7.

Therefore, it can be confirmed that, as in the present disclosure, vibration-damping material composition having a low specific gravity can be obtained only when calcium carbonate, mica, and glass bubbles are used together as a filler.

Meanwhile, the physical properties of the vibration-damping material compositions according to Examples 1 to 7 and the currently commercially available spray damping material (ASA-4002B, Shinsung Emulsification) are shown in Table 5 below.

Here, the commercial product includes 35% to 40% by weight of a single acrylic copolymer, 43% to 51% by weight of calcium carbonate, 10% to 15% by weight of a mica, 1% by weight of a colorant, 1% by weight of a dispersant, 1% by weight of an antifoaming agent, and 1% by weight of a thickener.

TABLE 5

| Test Items | | Commercial product | Example 1 to 7 |
|---|---|---|---|
| Specific gravity | | 1.62 | 0.98 to 1.28 |
| Vibration- | Loss factor | 0.12 | 0.15 to 0.192 |
| damping | (@ 20° C.) | | |
| performance | Loss factor | 0.12 | 0.224 to 0.284 |
| | (@ 40° C.) | | |

According to the results of Table 5, in the case of commercial products commercially available in the related art, a high specific gravity of 1.62 was shown. On the other hand, in Examples 1 to 7, it may be seen that the specific gravity is 1.3 or less, which is much lower than that of commercial products.

In addition, commercial products had a loss factor of 0.12 measured at 20° C. and 40° C., but in Examples 1 to 7, the loss factor measured at 20° C. was 0.15 or more, and the loss factor measured at 40° C. was 0.2 or more.

Therefore, the vibration-damping material composition, according to the present disclosure, has lower specific gravity and improved vibration-damping properties at high temperatures compared to conventional commercial products, thereby greatly contributing to the weight reduction of vehicles and maintaining vibration-damping properties even in high temperature environments. In addition, because viscosity and workability are at the same level compared to existing commercial products, there is an advantage that the vibration-damping material can be applied without additional application equipment and processes.

Although the embodiment of the present disclosure has been described above, it will be understood by those skilled in the art that the present disclosure may be implemented in other specific forms without changing the technical spirit or essential features thereof. Therefore, it should be understood that the embodiments described above are illustrative in all respects and not restrictive.

What is claimed is:

1. A vibration-damping material composition, the composition comprising:
an acrylic copolymer mixture comprising a first acrylic copolymer and a second acrylic copolymer, wherein the second acrylic copolymer has a higher weight-average molecular weight (Mw) and a higher glass transition temperature (Tg) than the first acrylic copolymer; and
a filler comprising a glass bubble, calcium carbonate, and a mica.

2. The composition of claim 1, wherein the composition comprises:
20% to 60% by weight of the acrylic copolymer mixture;
1% to 10% by weight of the glass bubble;
15% to 50% by weight of the calcium carbonate; and
5% to 20% by weight of the mica.

3. The composition of claim 1, wherein the acrylic copolymer mixture comprises the first acrylic copolymer and the second acrylic copolymer in a weight ratio in a range of 1:1 to 1:3.

4. The composition of claim 1, wherein the first acrylic copolymer has a weight-average molecular weight (Mw) in a range of 10,000 g/mol to 80,000 g/mol and a glass transition temperature (Tg) in a range of −30° C. to 0° C.

5. The composition of claim 1, wherein the second acrylic copolymer has a weight-average molecular weight (Mw) in a range of 40,000 g/mol to 120,000 g/mol and a glass transition temperature (Tg) in a range of −10° C. to 30° C.

6. The composition of claim 1, wherein the glass bubble has a specific gravity in a range of 0.1 to 2.0.

7. The composition of claim 1, wherein the glass bubble has an average particle diameter in a range of 10 μm to 30 μm.

8. The composition of claim 1, wherein the glass bubble has a crushing strength in a range of 30 MPa to 60 MPa.

9. The composition of claim 1, wherein the calcium carbonate has an average particle diameter in a range of 20 μm to 70 μm.

10. The composition of claim 1, wherein the mica has an average particle diameter in a range of 5 μm to 20 μm.

11. The composition of claim 1, further comprising:
an additive having a colorant, a dispersant, an antifoaming agent, a thickener, or any combination thereof.

12. The composition of claim 11, wherein the additive comprises, based on a total content of the composition:
0.1% to 3% by weight of the colorant;
0.1% to 3% by weight of the dispersant;
0.1% to 3% by weight of the antifoaming agent; and
5% to 20% by weight of the thickener.

13. The composition of claim 1, wherein the composition has a specific gravity of 1.3 or less as measured according to ISO 1183-1.

14. The composition of claim 1, wherein the composition has a loss factor of 0.15 or more measured at 20° C. and a loss factor of 0.2 or more measured at 40° C. according to ASTM E 756.
